(19) United States
(12) Patent Application Publication
(10) Pub. No.: US 2022/0347646 A1
(43) Pub. Date: Nov. 3, 2022

(54) LIGHT IRRADIATION DEVICE

(71) Applicant: HOYA CORPORATION, Tokyo (JP)

(72) Inventor: Taiji MIZUTA, Tokyo (JP)

(73) Assignee: HOYA CORPORATION, Tokyo (JP)

(21) Appl. No.: 17/864,334

(22) Filed: Jul. 13, 2022

Related U.S. Application Data
(63) Continuation of application No. PCT/JP2021/003865, filed on Feb. 3, 2021.

(30) Foreign Application Priority Data
Feb. 6, 2020 (JP) 2020-018428

(51) Int. Cl. B01J 19/12

(52) U.S. Cl. CPC B01J 19/123; B01J 2219/1203

(57) ABSTRACT

Provided is a light irradiation device capable of appropriately suppressing positional misalignment between optical axes even though a plurality of light source modules are disposed in series. A light irradiation device includes a plurality of light source modules disposed in series, in which the light source modules each include a substrate, LED elements disposed on a main surface of the substrate, and an optical element having sidewall sections installed uprightly on side sections of the substrate, and a lens section supported by the sidewall sections and positioned above the LED elements, in which the optical element is made by integrally forming the sidewall sections and the lens section from the same material, and in which a linear expansion coefficient of the substrate, a linear expansion coefficient of the optical element, and a difference in linear expansion coefficient between the substrate and the optical element are within specific ranges.

### TECHNICAL FIELD

The present invention relates to a light irradiation device.

### BACKGROUND ART

In the related art, ultraviolet curable ink, which is cured by being irradiated with ultraviolet rays, is used as ink for sheet-fed offset printing. In addition, ultraviolet curable resin is used as a sealing agent for a flat panel display (FPD) such as a liquid crystal panel or an organic EL (electroluminescence) panel.

In general, a light irradiation device configured to emit ultraviolet rays is used to cure the ultraviolet curable ink or the ultraviolet curable resin. However, in particular, it is necessary to emit ultraviolet rays having high irradiation intensity to a wide rectangular irradiation area for the purpose of sheet-fed offset printing or sealing of the FPD. Therefore, a light irradiation device having a wide light source (generally referred to as a line light source) disposed to face the irradiation area is used (e.g., see Patent Document 1).

In the related art, a low-pressure mercury lamp has been used as an ultraviolet emitting light source installed in the light irradiation device. However, recently, to meet the requirement of saving energy, the light source has been changed to a light source module having a substrate on which an LED element is disposed in a longitudinal direction (referred to as an LED package).

FIG. 8 is a schematic view for explaining an example of a light source module in the related art that is called the LED package.

In a light source module 111 in the related art illustrated in FIG. 8, a LED element 113 is disposed on a substrate 112, sidewall members 115 and 115 are installed uprightly on two opposite side sections of the substrate 112, and an optical element (rod lens) 114 is disposed above the substrate (in the drawing, a wire, an external electrode, and the like for supplying power to the LED element 113 are omitted).

In the example illustrated in FIG. 8, the sidewall members 115 are fixedly bonded to the substrate 112 by any bonding agent, and the optical element 114 is also fixedly bonded to the sidewall members 115 by any bonding agent.

However, because a horizontal width (a horizontal width of the irradiation area) of the light irradiation device varies depending on the types of devices and according to intended use, the light source module needs to be implemented as a unit, and a plurality of light source modules need to be disposed in series to correspond to the horizontal width of the light irradiation device on which the light source modules are to be installed.

FIG. 9 is a schematic view illustrating an example of the light irradiation device (line light source) 110 in which the plurality of light source modules 111 illustrated in FIG. 8 are installed in series side by side to be coincident with the longitudinal direction.

In the light irradiation device 110 illustrated in FIG. 9, three light source modules 111 are disposed in series, but the number of light source modules 111 to be disposed is optionally selected depending on the horizontal width of the light irradiation device (a horizontal width of an irradiation area implemented by the light irradiation device).

In the light irradiation device 110 illustrated in FIG. 9, typically, a wire for supplying power to the light source module 111 (LED element 113), a means for controlling the light source module 111, and a cooling means such as a heat sink or an air-cooled fan are embedded in a housing b.

When the light irradiation device 110 illustrated in FIG. 9 is used, power is supplied to the LED element 113 constituting each of the light source modules 111, and the plurality of optical elements 114 emit light in an upward direction based on the drawing.

### DOCUMENT OF RELATED ART

### Patent Document

Patent Document 1: Japanese Patent Laid-Open No. 2015-28915

### DISCLOSURE

### Technical Problem

However, according to the studies performed by the present inventors, the present inventors have found that positional misalignments between optical axes of the light source modules easily occur in the light irradiation device.

According to the additional studies related to the technical problem performed by the present inventors, the present inventors have found that in the light irradiation device 110 in which the plurality of light source modules 111 are disposed in series as illustrated in FIG. 9, the ambient temperature or the temperature of the optical element 114 is raised as the LED element 113 is turned on during the operation, the optical element 114 is thermally expanded, and as a result, the positions of the LED element 113 and the optical element 114 deviate from design values or the adjacent optical elements 114 come into contact with each other and thus be deformed or titled, which makes it easy to cause the positional misalignment between the optical axes.

In addition, according to the studies performed by the present inventors, the present inventors have found that when a linear expansion coefficient of any one of the substrate 112, the sidewall member 115, and the optical element 114 is large or when a difference in linear expansion coefficient between the substrate 112 and the sidewall member 115 or a difference in linear expansion coefficient between the sidewall member 115 and the optical element 114 is large in the light source module 111 constituting the light irradiation device 110 illustrated in FIG. 9, thermal stress occurs on the portions where the above-mentioned components are fixedly bonded, which causes deformation or tilting and thus easily causes the positional misalignment between the optical axes.

The present invention has been contrived in consideration of the above-mentioned situations, and an object of the present invention is to provide a light irradiation device capable of appropriately suppressing positional misalignment between optical axes even though a plurality of light source modules are disposed in series.

### Technical Solution

According to the additional studies performed by the present inventors based on the above-mentioned fact, the present inventors complete the present invention after founding that the technical problem may be solved by a light irradiation device including a plurality of light source modules disposed in series, in which the light source modules each include a substrate, LED elements disposed on a main surface of the substrate, and an optical element having sidewall sections installed uprightly on side sections of the substrate, and a lens section supported by the sidewall sections and positioned above the LED elements, in which the optical element is made by integrally forming the sidewall sections and the lens section from the same material, and in which a linear expansion coefficient of the substrate constituting the light source module, a linear expansion coefficient of the optical element, and a difference in linear expansion coefficient between the substrate and the optical element are within specific ranges.

That is, the present invention provides (1) a light irradiation device including: a plurality of light source modules disposed in series, in which the light source modules each comprise: a substrate; LED elements disposed on a main surface of the substrate; and an optical element having sidewall sections installed uprightly on side sections of the substrate, and a lens section supported by the sidewall sections and positioned above the LED elements, in which the optical element is made by integrally forming the sidewall sections and the lens section from the same material, in which a linear expansion coefficient of the substrate is 0×10⁻⁶/K to 30×10⁻⁶/K, in which a linear expansion coefficient of the optical element is 0×10⁻⁶/K to 10×10⁻⁶/K, and in which a difference in linear expansion coefficient, which is expressed as (Linear expansion coefficient of substrate−Linear expansion coefficient of optical element), is 0×10⁻⁶/K to 25×10⁻⁶/K.

The light irradiation device disclosed in (1), in which the sidewall sections of the optical element are not fixedly bonded to the substrate.

The light irradiation device disclosed in (1) or (2), in which the sidewall section is fixed to the optical element or the substrate by means of one or more means selected from a pressing member, a fitting groove, and a fitting pin.

### Advantageous Effects

According to the present invention, the linear expansion coefficient of the optical element is equal to or smaller than the linear expansion coefficient of the substrate (Linear expansion coefficient of optical element≤Linear expansion coefficient of substrate). Therefore, the arrangement interval between the adjacent light source modules is adjusted to an interval at which the substrates are not in contact with each other even though the substrates are thermally expanded. Therefore, the optical elements are not in contact with each other even though the adjacent optical elements are thermally expanded. As a result, it is possible to appropriately suppress the positional misalignment between the optical axes by suppressing the deformation or tilting of the optical element.

In addition, according to the present invention, the linear expansion coefficients of the components such as the substrate constituting the light source module and the optical element and the difference in linear expansion coefficient between the adjacent components are controlled to be within the specific ranges. Therefore, it is possible to suppress the occurrence of thermal stress between the components, thereby suppressing the positional misalignment between the optical axes caused by the deformation or tilting. Therefore, according to the present invention, it is possible to provide the light irradiation device capable of appropriately suppressing the positional misalignment between the optical axes even though the plurality of light source modules are disposed in series.

### DESCRIPTION OF DRAWINGS

FIG. 1 is a schematic view illustrating an embodiment of a light source module constituting a light irradiation device according to the present invention.

FIG. 2 is a schematic view illustrating a lateral side of the light source module illustrated in FIG. 1.

FIG. 3 is a view for explaining a height of a sidewall section.

FIG. 4 is a schematic view illustrating a cross-section of a lateral side of the embodiment of the light irradiation device according to the present invention.

FIG. 5 is a schematic view of a lateral side of the embodiment of the light source module constituting the light irradiation device according to the present invention.

FIG. 6 is a schematic view of a lateral side of the embodiment of the light source module constituting the light irradiation device according to the present invention.

FIG. 7 is a schematic view illustrating the embodiment of the light irradiation device according to the present invention.

FIG. 8 is a schematic view for explaining an embodiment of a light source module (LED package) which is a comparative example of the present invention.

FIG. 9 is a schematic view illustrating an embodiment of a light irradiation device in which a plurality of light source modules illustrated in FIG. 8 are installed in series side by side.

### EXPLANATION OF REFERENCE NUMERALS AND SYMBOLS

10, 110: Light irradiation device
11, 111: Light source module
12, 112: Substrate
13, 113: LED element
14, 114: Optical element
14a: Lens section
14b: Sidewall section
15, 115: Sidewall member
b: Housing
c: Upper wall surface
s: Flat spring
g: Groove
p: Fitting pin
hs: Heat sink

### BEST MODE

A light irradiation device according to the present invention will be described.

That is, the present invention provides a light irradiation device including: a plurality of light source modules disposed in series, in which the light source modules each comprise: a substrate; LED elements disposed on a main surface of the substrate; and an optical element having sidewall sections installed uprightly on side sections of the substrate, and a lens section supported by the sidewall sections and positioned above the LED elements, in which the optical element is made by integrally forming the sidewall sections and the lens section from the same material, in which a linear expansion coefficient of the substrate is 0×10⁻⁶/K to 30×10⁻⁶/K, in which a linear expansion coefficient of the optical element is 0×10⁻⁶/K to 10×10⁻⁶/K, and in which a difference in linear expansion coefficient, which is expressed as (Linear expansion coefficient of substrate−Linear expansion coefficient of optical element), is 0×10⁻⁶/K to 25×10⁻⁶/K.

Hereinafter, the light irradiation device according to the present invention will be described with reference to the proper drawings.

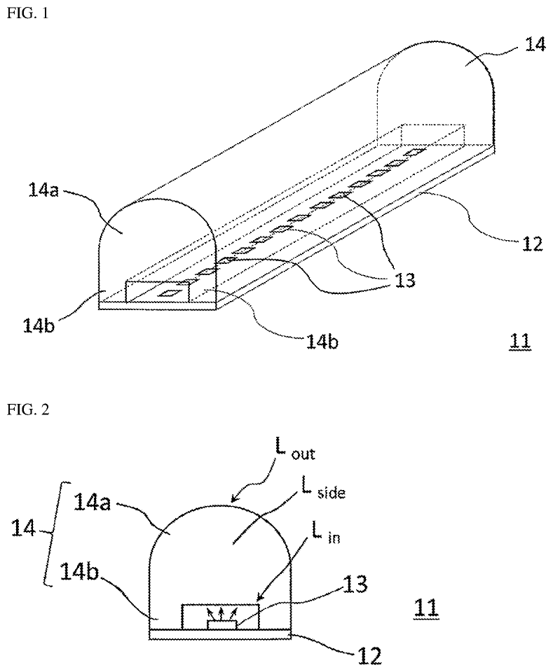

FIG. 1 is a schematic view illustrating an embodiment of a light source module constituting a light irradiation device according to the present invention.

As illustrated in FIG. 1, in a light irradiation device according to the present invention, a light source module 11 includes a substrate 12, LED elements 13 disposed on a main surface of the substrate, sidewall sections 14b and 14b installed uprightly on side sections of the substrate 12, and an optical element 14 supported on the sidewall sections 14b and 14b and having a lens section 14a positioned above the LED elements 13.

As illustrated in FIG. 1, in the light irradiation device according to the present invention, the substrate 12 constituting the light source module 11 typically has a rectangular shape when viewed from the front side.

In the light irradiation device according to the present invention, a material of the substrate may be, for example, a ceramics material having insulation or a metallic material.

For example, the ceramics material having insulation may be one or more ceramics materials selected from aluminum oxide, aluminum nitride, silicon nitride, and silicon carbide.

In addition, for example, the metallic material may be one or more selected from copper, aluminum, and the like.

In the light irradiation device according to the present invention, a linear expansion coefficient of the substrate may be 0×10⁻⁶/K to 30×10⁻⁶/K, particularly, 0×10⁻⁶/K to 8×10⁻⁶/K.

The linear expansion coefficient of the substrate may be easily controlled by appropriately selecting a material for forming the substrate.

In addition, in the present application, the linear expansion coefficient of the substrate means a value measured by JIS Z1618 “Method of measuring linear expansion coefficient of fine ceramics” on the substrate made of a ceramics material. The linear expansion coefficient of the substrate means a value measured by JIS Z2285 “Method of measuring linear expansion coefficient of metallic material” on the substrate made of a metallic material.

In the light irradiation device according to the present invention, the linear expansion coefficient of the substrate constituting the light source module is within a specific range, such that it is possible to easily suppress a degree of thermal expansion of the substrate within a desired range.

In the light irradiation device according to the present invention, as illustrated in FIG. 1, the LED elements 13 are disposed on the main surface of the substrate 12 constituting the light source module 11.

The LED element may be appropriately selected according to intended use. For example, when the LED element is used to cure ultraviolet curable ink or ultraviolet curable resin, the LED element may be appropriately selected from ultraviolet LEDs.

As illustrated in FIG. 1, when the plurality of LED elements 13 are disposed in the longitudinal direction of the substrate 12, the plurality of LED elements may be disposed in a row or multiple rows. In this case, the arrangement interval between the LED elements or the size of the LED element may be optionally selected.

Although not illustrated in FIG. 1, the LED elements 13 are each electrically connected by a publicly-known method.

For example, when the substrate 12 is made of a ceramics material having insulation, a cathode terminal and an anode terminal of the LED element 13 (light-emitting diode) are respectively and electrically connected to a negative pattern and a positive pattern provided by using a conductive material on the substrate 12.

As illustrated in FIG. 1, in the light irradiation device according to the present invention, the optical element 14 includes the sidewall sections 14b and 14b installed uprightly on the side sections of the substrate 12, and the lens section 14a supported by the sidewall sections and positioned above the LED elements 13.

In the light irradiation device according to the present invention, a material of the optical element is not particularly limited as long as the material capable of transmitting LED light. When the ultraviolet LED is adopted as the LED element, the material of the optical element may have resistance against the ultraviolet rays.

Specifically, the material of the optical element may be one or more materials selected from quartz such as synthetic quartz or molten quartz and hard glass.

The hard glass may be one or more materials selected from borosilicate glass (Si—B—O-based glass, softening point: about 800° C.) and aluminosilicate glass (Si—Al—O-based glass, softening point: about 900° C.) or a material made by adding one or more materials selected from alkaline earth oxide, alkaline oxide, and metal oxide into any one of the above-mentioned materials.

In the light irradiation device according to the present invention, an appropriate combination of the materials of the substrate and the optical element may be any one combination of the following combinations 1 to 4.

(1) (substrate) aluminum nitride, (optical element) quartz

(2) (substrate) alumina, (optical element) quartz

(3) (substrate) copper, (optical element) borosilicate glass

(4) (substrate) aluminum, (optical element) borosilicate glass

In the light irradiation device according to the present invention, the optical element is made by integrally forming the sidewall sections and the lens section from the same material.

FIG. 2 is a schematic view illustrating a lateral side of the light source module 11 illustrated in FIG. 1.

As illustrated in FIG. 2, a light incident surface (Lin) of the lens section 14a of the optical element may be a planar shape or a curved shape such as a convex or concave shape.

In addition, as illustrated in FIG. 2, the light emergent surface (Lout) of the lens section 14a of the optical element may be a spherical shape or a curved or aspherical shape such as a convex or concave shape.

The light incident surface (Lin) and the light emergent surface (Lout) of the lens section 14a illustrated in FIG. 2 are typically an optical surface.

A lateral side (Lside) of the lens section 14a illustrated in FIG. 2 may be an optical surface, but may have a concave-convex shape as long as the lateral side may transmit the light in the upward direction based on FIG. 2.

In the light irradiation device according to the present invention, a height of the sidewall section of the optical element is not particularly limited as long as the height is equal to or higher than a height of the LED element.

FIG. 3 is a view for explaining the height of the sidewall section and corresponding to FIG. 2. The length (h) illustrated in FIG. 3 corresponds to the height of the sidewall section 14b of the optical element 14 illustrated in the same drawing.

In the light irradiation device according to the present invention, the height of the sidewall section of the optical element means a minimum value of a distance (vertical length) between the substrate and the light incident surface of the optical element facing the substrate.

In the example illustrated in FIG. 3, because the vertical length (h) between the substrate 12 and the light incident surface (Lin) is constant over the entire light incident surface, the length (h) corresponding to the height of the sidewall section 14b.

In the light irradiation device according to the present invention, the optical element is made by integrally forming the sidewall sections and the lens section (the sidewall sections 14b and the lens section 14a in the example illustrated in FIG. 1) from the same material.

The optical element made by integrally forming the sidewall sections and the lens section from the same material may be ground or polished to have the desired shapes of the sidewall sections and the lens section or formed by various types of forming methods such as injection molding, molding, press-forming, or sintering.

In the light irradiation device according to the present invention, because the optical element is made by integrally forming the sidewall sections and the lens section from the same material, the sidewall section and the lens section are expanded to the same degree even at a high temperature, and there is no interface (joint portion) between the sidewall section and the lens section, which makes it possible to appropriately suppress the occurrence of thermal stress.

In the light irradiation device according to the present invention, the shape of the sidewall section of the optical element is not particularly limited as long as the sidewall section may support the lens section on the substrate.

In the light irradiation device according to the present invention, as illustrated in FIG. 1, the pair of sidewall sections 14b and 14b may support the lens section 14a or only one sidewall section 14b may support the lens section 14a.

In addition, in the light irradiation device according to the present invention, as illustrated in FIG. 1, the sidewall section 14b installed in the overall longitudinal direction of the substrate 12 may support the lens section 14a or the sidewall section installed only in a part of the longitudinal direction of the substrate 12 may support the lens section.

In the light irradiation device according to the present invention, a linear expansion coefficient of the optical element may be 0×10⁻⁶/K to 10×10⁻⁶/K, particularly, 0×10⁻⁶/K to 4×10⁻⁶/K.

The linear expansion coefficient of the optical element may be easily controlled by appropriately selecting a material for forming the optical element.

In addition, in the present application, the linear expansion coefficient of the optical element means a value measured by a method of testing an average linear expansion coefficient of glass specified in JIS R3102.

In the light irradiation device according to the present invention, the linear expansion coefficient of the optical element constituting the light source module is within a specific range, such that it is possible to easily suppress the degree of thermal expansion of the optical element within a desired range, thereby easily suppressing the positional misalignment between the optical axes.

In the light irradiation device according to the present invention, the difference in linear expansion coefficient, which is expressed as “Linear expansion coefficient of substrate−Linear expansion coefficient of optical element” may be 0×10⁻⁶/K to 25×10⁻⁶/K, particularly, 0×10⁻⁶/K to 5×10⁻⁶/K.

The difference in linear expansion coefficient may be easily controlled by appropriately selecting materials for forming the substrate and the optical element.

In the light irradiation device according to the present invention, when the arrangement interval between the adjacent light source modules is adjusted to an interval at which the adjacent light source modules do not come into contact with each other even though the substrate is thermally expanded because the difference in linear expansion coefficient, which is expressed as “Linear expansion coefficient of substrate−Linear expansion coefficient of optical element” is “0” or “a positive value”, i.e., the linear expansion coefficient of the optical element is equal to or smaller than the linear expansion coefficient of the substrate, the adjacent light source modules do not come into contact with each other even though the adjacent optical elements thermally expanded, such that it is possible to easily suppress the deformation or tilting of the optical element, thereby appropriately suppressing the positional misalignment between the optical axes.

In addition, in the light irradiation device according to the present invention, the difference in linear expansion coefficient, which is expressed as “Linear expansion coefficient of substrate−Linear expansion coefficient of optical element” is within the range, i.e., an absolute value of the difference in linear expansion coefficient between the substrate and the optical element is controlled to the range. Therefore, it is possible to suppress the occurrence of thermal stress in the substrate and the optical element, thereby appropriately suppressing the positional misalignment between the optical axes caused by the deformation or tilting.

In the light irradiation device according to the present invention, the sidewall section of the optical element may not be fixedly bonded to the substrate.

That is, in the embodiment illustrated in FIG. 1, the sidewall sections 14b and 14b of the optical element 14 may not be fixedly bonded to the substrate.

As illustrated in FIG. 1, in the light irradiation device according to the present invention, when the LED elements 13 emit light during the operation of the light irradiation device and the ambient temperature is raised to a high temperature, the substrate 12 and the optical element 14 constituting the light source module 11 are thermally expanded. In this case, if the substrate 12 and the optical element 14 are fixedly bonded to each other, thermal stress occurs on the interface between the substrate 12 and the optical element 14, such that the substrate 12 and the optical element 14 are easily deformed or tilted.

In contrast, in the light irradiation device according to the present invention, when the sidewall section of the optical element is not fixedly bonded to the substrate, any one of or both the substrate and the optical element slide on the interface between the substrate and the optical element when any one of or both the substrate and the optical element are thermally expanded. Therefore, it is possible to suppress the occurrence of thermal stress between the substrate and the optical element.

In addition, in the light irradiation device according to the present invention, the light source module, which has been used for a predetermined period of time, is regularly separated and replaced depending on the duration of the LED element. Because the duration of the optical element is longer than that of the LED element, the optical element may be reused.

In this case, because the sidewall section of the optical element is not fixedly bonded to the substrate, the optical element may be easily separated from the light source module, and the light source module may be easily reused as a component.

In the light irradiation device according to the present invention, when the sidewall section of the optical element may not be fixedly bonded to the substrate, the optical element and the substrate may be fixed by a fastener so that the arrangement positions thereof are maintained.

The fastener is not particularly limited as long as the fastener is a means capable of sliding to a predetermined degree on the interface between the optical element and the substrate.

For example, the fastener may be one or more means selected from a pressing member, a fitting groove, and a fitting pin.

When the optical element and the substrate is fixed by means of a pressing member, the pressing member may be a flat spring, for example.

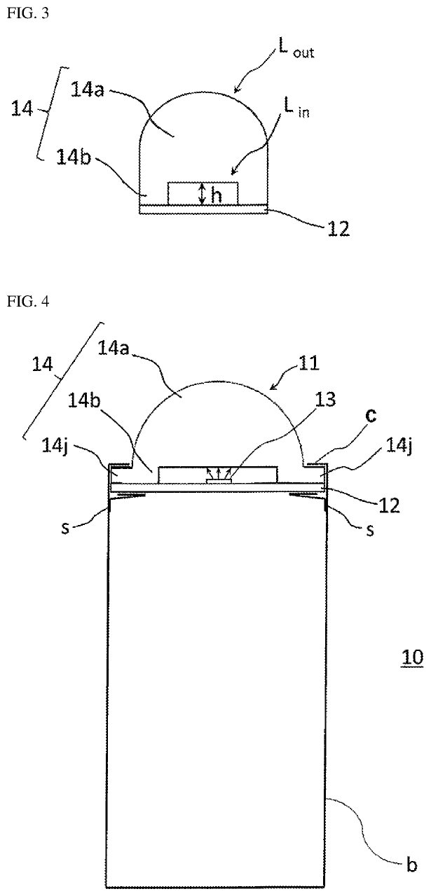

FIG. 4 is a schematic view illustrating a cross-section of a lateral side of the embodiment of the light irradiation device according to the present invention.

In the light irradiation device 10 illustrated in FIG. 4, the light source module 11 includes the substrate 12, the LED elements 13 disposed on the main surface of the substrate, and the optical element 14 including the pair of sidewall sections 14b installed uprightly on the side sections of the substrate 12, and the lens section 14a supported by the sidewall sections and positioned above the LED elements 13.

In the embodiment illustrated in FIG. 4, the optical element 14 and the substrate 12 constituting the light source module 11 are pressed by the flat spring (s) in the upward direction based on the drawing and fitted between the flat spring (s) and an upper wall surface (c) of the housing.

In this case, the substrate 12 is pushed by the flat spring (s) in the upward direction based on the drawing, and the optical element 14 is pushed by the upper wall surface (c) of the housing (b) in the downward direction based on the drawing.

As illustrated in FIG. 4, a protruding portion 14j may be installed on at least a part of the light emergent surface of the optical element 14 and configured to be pushed in a direction toward the substrate so that the optical element 14 is effectively pushed in the downward direction based on the drawing (pushed toward the substrate 12).

As illustrated in FIG. 4, the optical element is fixed by the pressing member instead of fixedly bonding the optical element to the substrate constituting the light source module. Therefore, even though any one of or both the substrate and the optical element are thermally expanded and deformed as a whole in the longitudinal direction (in a direction from the front surface toward the back surface of the drawing in the example illustrated in FIG. 4), the substrate and the optical element are deformed while sliding on the interface between the substrate and the optical element. Therefore, it is possible to appropriately fix the substrate and the optical element while appropriately suppressing the occurrence of thermal stress.

When the optical element and the substrate are fixed by the fitting grooves, the fitting grooves may be grooves into which the bottom portions of the sidewall sections of the optical element installed on the surface of the substrate surface are fitted.

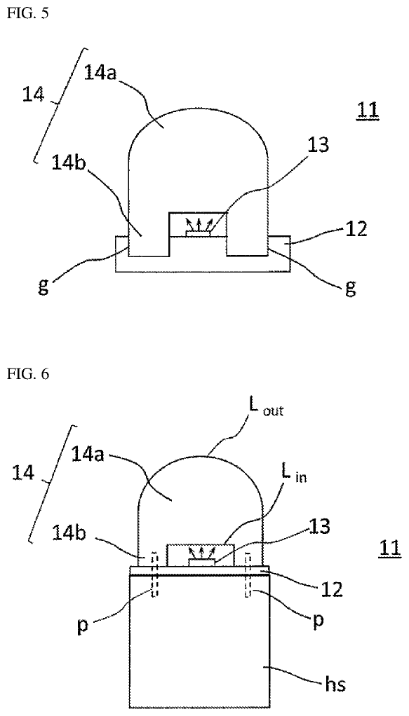

FIG. 5 is a schematic view of a lateral side of the embodiment of the light source module constituting the light irradiation device according to the present invention.

The light source module 11 illustrated in FIG. 5 includes the substrate 12, the LED elements 13 disposed on the main surface of the substrate, and the optical element 14 including the sidewall sections 14b and 14b installed uprightly on the side sections of the substrate 12, and the lens section 14a supported by the sidewall sections and positioned above the LED elements 13.

In the embodiment illustrated in FIG. 5, grooves (g and g) are formed in the substrate 12, and the bottom portions of the sidewall sections 14b and 14b of the optical element 14 constituting the light source module 11 are fitted into the grooves (g), such that the optical element 14 may be fixed to the substrate 12.

As illustrated in FIG. 5, the bottom portions of the sidewall sections of the optical element constituting the light source module are fixed by being fitted into the grooves formed in the substrate instead of fixedly bonding the optical element to the substrate constituting the light source module. Therefore, even though any one of or both the substrate and the optical element are thermally expanded and deformed as a whole in the longitudinal direction (in a direction from the front surface toward the back surface of the drawing in the example illustrated in FIG. 5), the substrate and the optical element are deformed while sliding on the interface between the substrate and the optical element. Therefore, it is possible to appropriately fix the substrate and the optical element while appropriately suppressing the occurrence of thermal stress.

When the optical element and the substrate are fixed by means of a fitting pin, the light source module has a heat sink provided on the main surface of the substrate opposite to the main surface on which the LED elements are installed. The sidewall section of the optical element may be fixed to the heat sink by means of the fitting pin through a through-hole formed in the substrate.

FIG. 6 is a schematic view of a lateral side of the embodiment of the light source module constituting the light irradiation device according to the present invention.

The light source module 11 illustrated in FIG. 6 includes the substrate 12, the LED elements 13 disposed on the main surface of the substrate, and the optical element 14 including the sidewall sections 14b installed uprightly on the side sections of the substrate 12, and the lens section 14a supported by the sidewall sections and positioned above the LED elements 13. The light source module 11 further includes the heat sink (hs) provided on the opposite main surface of the substrate 12.

In the embodiment illustrated in FIG. 6, a plurality of through-holes are formed in the substrate 12, and fitting pins (p) are inserted into the through-hole, such that the sidewall sections 14b of the optical element may be fixed to the heat sink (hs) by means of the through-holes. The fitting pin may be a positioning pin or the like.

When the optical element and the sidewall member are fixed by means of the fitting pins, only the longitudinal central portions of the optical element and the sidewall member may be fixed by means of the fitting pins, and the two longitudinal opposite ends of the optical element and the sidewall member may not be fixed, for example, in order to suppress the occurrence of thermal stress on the interface of the optical element and the sidewall member.

As illustrated in FIG. 6, when the optical element and the substrate are fixed by means of the fitting pins instead of fixedly bonding the optical element to the substrate constituting the light source module, the degree of the positional misalignment of the substrate or the optical element caused by the deformation is low at the longitudinal central portion and high at the two opposite ends when any one of or both the substrate and the optical element are thermally expanded and deformed as a whole in the longitudinal direction (in a direction from the front surface to the back surface of the drawing in the example illustrated in FIG. 6).

Therefore, when only the longitudinal central portions of the optical element and the sidewall member are fixed by means of the fitting pins, it is possible to appropriately suppress the occurrence of thermal stress between the optical element and the sidewall member and appropriately fix the substrate and the optical element.

In the embodiment illustrated in FIGS. 4 to 6, because the substrate 12 and the optical element 14 are not fixedly bonded to each other, the optical element 14 may be easily separated from the light source module 10 and easily reused as a component of the light source module when the light source module 10 is replaced.

In the light irradiation device according to the present invention, the plurality of light source modules are disposed in series (to be coincident with the longitudinal direction).

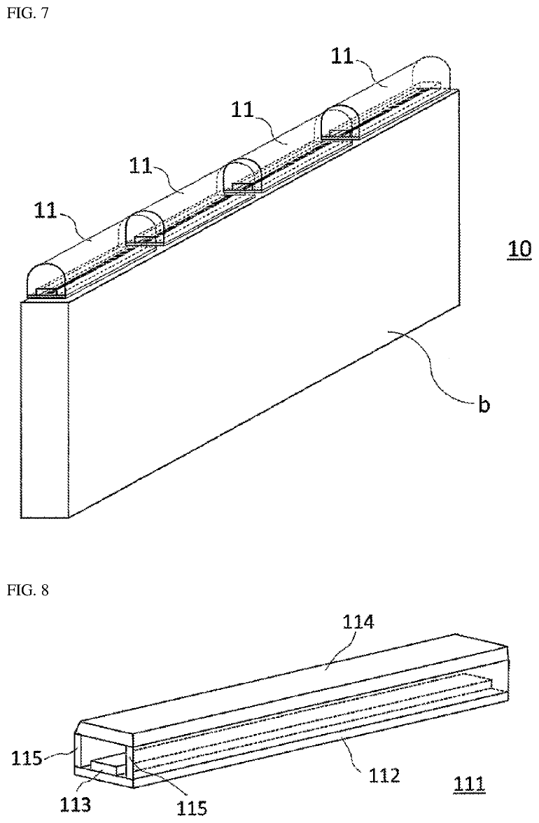

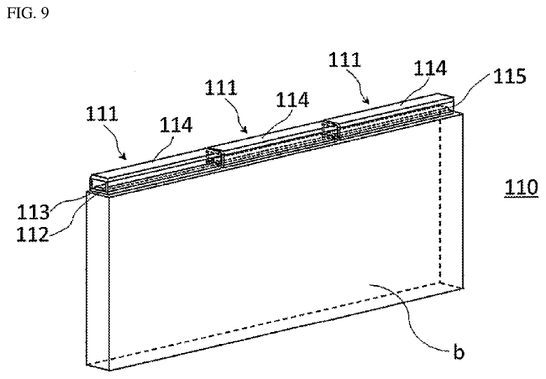

FIG. 7 is a schematic view illustrating the embodiment of the light irradiation device according to the present invention.

In the example illustrated in FIG. 7, FIG. 7 illustrates the light irradiation device 10 in which four light source modules 11 are fixed in series to the housing (b). However, in the present invention, the number of light source modules 11 to be disposed on the light irradiation device is not particularly limited.

A wire for supplying power to the light source module 11 (LED element 13), a means for controlling the light source module 11, and a cooling means such as a heat sink or an air-cooled fan may be embedded in the housing b.

In the light irradiation device according to the present invention, the arrangement interval between the plurality of light source modules is not particularly limited as long as the interval is an interval at which the adjacent substrates are not in contact with each other even though the substrates are thermally expanded at an ambient temperature when the light irradiation device is used.

In the light irradiation device according to the present invention, the length of the substrate increases by L×α×ΔT(m) during the operation of the light irradiation device when a longitudinal length of the substrate constituting the light source module (before the operation of the light irradiation device) is L(m), the linear expansion coefficient of the substrate is α (×10⁻⁶/K), a raised ambience temperature during the operation of the light irradiation device is ΔT(K).

For this reason, the length L′ of the substrate during the operation of the light irradiation device may be calculated by the following equation.

L′(m)=L+L×α×ΔT

Assuming that the length of each of the substrates increases by (L×α×ΔT)/2(m) relative to the adjacent substrate, it is possible to suppress the contact between the substrates by setting the arrangement interval between the adjacent substrates to a value larger than L×α×ΔT(m).

According to the present invention, the linear expansion coefficient of the optical element is equal to or smaller than the linear expansion coefficient of the substrate (Linear expansion coefficient of optical element≤Linear expansion coefficient of substrate). Therefore, the arrangement interval between the adjacent light source modules is adjusted to an interval at which the substrates are not in contact with each other even though the substrates are thermally expanded. Therefore, the optical elements are not in contact with each other even though the adjacent optical elements are thermally expanded. As a result, it is possible to appropriately suppress the positional misalignment between the optical axes by suppressing the deformation or tilting of the optical element.

In addition, according to the present invention, the linear expansion coefficient of the substrate constituting the light source module, the linear expansion coefficient of the optical element, and the difference in linear expansion coefficient between the substrate and the optical element are controlled to be within the specific ranges. Therefore, it is possible to suppress the occurrence of thermal stress between the substrate and the optical element, thereby suppressing the positional misalignment between the optical axes caused by the deformation or tilting.

Therefore, according to the present invention, it is possible to provide the light irradiation device capable of appropriately suppressing the positional misalignment between the optical axes even though the plurality of light source modules are disposed in series.

### INDUSTRIAL APPLICABILITY

According to the present invention, it is possible to provide the light irradiation device capable of appropriately suppressing the positional misalignment between the optical axes even though the plurality of light source modules are disposed in series.

What is claimed is:

1. A light irradiation device comprising:
a plurality of light source modules disposed in series,
wherein the light source modules each comprise:
a substrate;
LED elements disposed on a main surface of the substrate; and
an optical element having sidewall sections installed uprightly on side sections of the substrate, and a lens section supported by the sidewall sections and positioned above the LED elements,
wherein the optical element is made by integrally forming the sidewall sections and the lens section from the same material,
wherein a linear expansion coefficient of the substrate is 0×10⁻⁶/K to 30×10⁻⁶/K,
wherein a linear expansion coefficient of the optical element is 0×10⁻⁶/K to 10×10⁻⁶/K, and
wherein a difference in linear expansion coefficient, which is expressed as (Linear expansion coefficient of substrate−Linear expansion coefficient of optical element), is 0×10⁻⁶/K to 25×10⁻⁶/K.

2. The light irradiation device of claim 1, wherein the sidewall sections of the optical element are not fixedly bonded to the substrate.

3. The light irradiation device of claim 1, wherein the sidewall section is fixed to the optical element or the substrate by means of one or more means selected from a pressing member, a fitting groove, and a fitting pin.

4. The light irradiation device of claim 2, wherein the sidewall section is fixed to the optical element or the substrate by means of one or more means selected from a pressing member, a fitting groove, and a fitting pin.
